(19) United States
(12) Patent Application Publication
(10) Pub. No.: US 2010/0131417 A1
(43) Pub. Date: May 27, 2010

(54) ENHANCING COPYRIGHT REVENUE GENERATION

(76) Inventor: Hank RISAN, Santa Cruz, CA (US)

Correspondence Address: MEDIA RIGHTS TECHNOLOGIES C/O WAGNER BLECHER LLP, 123 WESTRIDGE DRIVE, WATSONVILLE, CA, 95076, US

(21) Appl. No.: 12/323,376

(22) Filed: Nov. 25, 2008

(51) Int. Cl. G06Q 30/00; G06Q 50/00; G10L 19/00

(52) U.S. Cl. 705/310; 704/200.1; 704/E19.001

(57) ABSTRACT

A method and system for enhancing copyright revenue generation is disclosed. The method includes receiving a copyrighted media recording, creating an independent work of authorship by generating a simulation of the copyrighted media recording, such that the independent work of authorship is entitled to a copyright and utilizing the simulation in place of the copyrighted media recording, such that use of the independent work of authorship may be entitled to copyright royalties thereon as opposed to requiring copyright royalties for use of the copyrighted media recording.

### FIELD

Embodiments of the present technology relates generally to the field of copyright revenue.

### BACKGROUND

Downloading media over the Internet is quite popular. End users often download one's favorite songs so the end user may listen to the songs repeatedly at his/her convenience. The media being transmitted to the end user often has copyright protection under Title 17 of the United States Code. If the downloaded media is copyright protected, copyright royalties may be required to legally transmit and subsequently download the media. Accordingly, a media provider that provides a large database of media may transmit large volumes of copyrighted media and may be required to pay large royalty fees.

### SUMMARY

A method and system for enhancing copyright revenue generation is disclosed. The method includes receiving a copyrighted media recording, creating an independent work of authorship by generating a simulation of the copyrighted media recording, such that the independent work of authorship is entitled to a copyright and utilizing the simulation in place of the copyrighted media recording, such that use of the independent work of authorship may be entitled to copyright royalties thereon as opposed to requiring copyright royalties for use of the copyrighted media recording.

### BRIEF DESCRIPTION OF THE DRAWINGS

FIG. 1 illustrates an example of a system for enhancing copyright revenue generation, in accordance with an embodiment of the present invention.

FIG. 2 illustrates an example of a flow chart of a method for enhancing copyright generation, in accordance with an embodiment of the present invention.

FIG. 3 illustrates an example of a computer system, in accordance with an embodiment of the present invention.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Under 17 U.S.C. 114, an owner of copyright in a sound recording has exclusive rights to the sound recording. For example, the copyright owner is limited to the right to duplicate the sound recording in certain forms that directly or indirectly recapture the actual sounds fixed in the recording. Also, the copyright owner is limited to the right to prepare a derivative work in which the actual sounds fixed in the sound recording are rearranged, remixed, or otherwise altered in sequence or quality.

However, there are certain limitations to the rights in the sound recordings. In particular, the exclusive rights of the owner of copyright in a sound recording do not extend to the making or duplication of another sound recording that consists entirely of an independent fixation of other sounds, even though such sounds imitate or simulate those in the copyrighted sound recording. In other words, copyright law allows one to create an imitation or simulation of a copyrighted sound recording as long as the imitated or simulated sounds are independently created. Copyright law also requires a plurality of copyright royalties paid to the copyright owner for the use of copyrighted work.

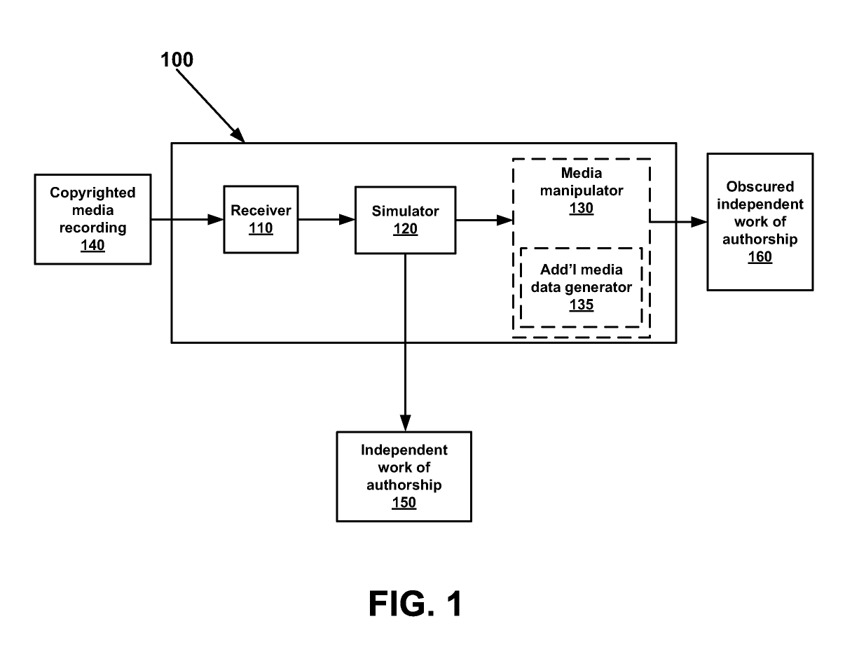

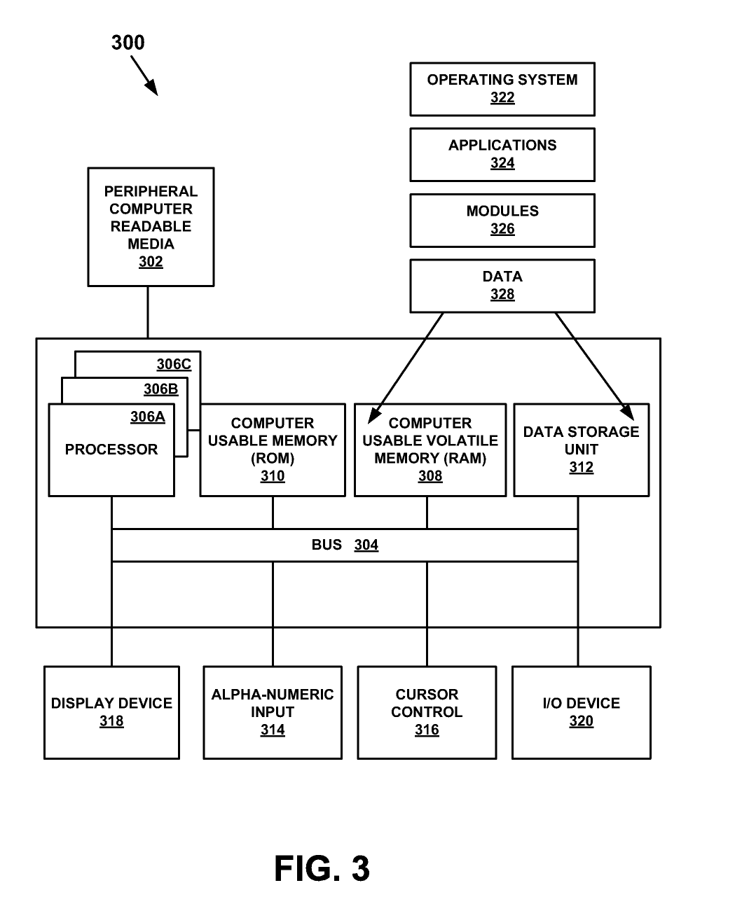

As described above, a media provider that provides a large database of media, such as but not limited to sound recordings, may transmit large volumes of copyrighted media and may be required to pay large amounts of royalty fees. An embodiment in accordance with the present invention provides a system 100 for enhancing copyright revenue generation, as illustrated in FIG. 1. The system 100 includes a receiver 110 configured to receive a copyrighted media recording 140. A simulator 120 is configured to analyze the copyrighted media recording 140 and generates an independent work of authorship 150 based on an analysis of the copyrighted media recording, such that the independent work of authorship is entitled to a copyright and use of the independent work of authorship may be entitled to copyright royalties thereon as opposed to requiring copyright royalties for use of the copyrighted media recording. All of, or a portion of, the system 100 may reside in a computer-readable and computer-executable instructions which reside, for example, in computer-usable media of a computer system, such as but not limited to the computer system in FIG. 3. In one embodiment, system is performed in a computer system, e.g., system 300 of FIG. 3.

Prior to the receiver 110 of the system 100 receiving the copyrighted media recording 140, sufficient rights have been acquired to obtain the copyrighted media recording. In one embodiment, the sufficient rights may be permission by the owner of the copyright of the copyrighted media recording to receive the media recording. In another embodiment, the sufficient rights are acquired by a one-time mechanical license. A mechanical license allows for limited rights, such as but not limited to making a copy of the copyrighted media recording 140. In one embodiment, the copy of the copyrighted media recording is in binary format such as in the form of a WAV file.

The simulator 120 generates an independent work of authorship 150 that is entitled to its own copyright protection because it is a wholly new work that is independently created from the copyrighted media recording. In one embodiment, the simulator 120 is a psychoacoustic simulator configured to psychoacoustically analyze the copyrighted media recording 140 and create an independent work of authorship 150 by generating a psychoacoustic simulation of the copyrighted media recording. It can be appreciated that the independent work of authorship is entitled to copyright protection once it is created. However, additional copyright protection is provided for the independent work by obtaining a copyright registration on the independent work of authorship.

In general, pscyhoacoustics allows for the creation of mathematical modeling to trick the brain that it is hearing the original sounds but instead it is hearing another sound that is quite different. In one embodiment, the psychoacoustic simulator creates an independent work of authorship 150 by reading a digital rendition of the copyrighted media recording and mathematically modeling the original sounds. It is appreciated that any psychoacoustic modeling can be performed by the psychoacoustic simulator. It is important to note that the psychoacoustic simulator does not copy, capture, edit and/or sample any part of the copyrighted media recording 140. The term “sample” is defined in the context of copyright law. In general, under copyright law, sampling is the use of actual sounds in a copyrighted work and modifying those sounds. For example, sampling can be reversing the order or replaying a sequence of the sound.

In one embodiment, the receiver 110 and the simulator 120 can be distributed. In another embodiment the receiver 110 and the simulator 120 can be integrated. It can be appreciated that for security purposes a firewall can be implemented between the receiver 110 and the simulator 120 to ensure that the output of the simulator is an independent work of authorship 150 that is wholly new and independent artistic expression as opposed to a mere mechanical rendition of the copyrighted media recording 140.

The system 100 can include a media manipulator 130 which is configured to obscure the independent work of authorship 150 and create an obscured independent work of authorship 160, such that the independent work of authorship is not fully perceptible without authority of the copyright owner of the independent work of authorship. In one embodiment, the media manipulator 130 obscures the independent work of authorship by embedding data onto the independent work of authorship. In another embodiment, the media manipulator affixes multiple layers of data onto the independent work of authorship. In a further embodiment, the media manipulator affixes a unique atonal cacophonous sound to the independent work of authorship to dissuade illicit copying. Without the requisite authority and consent, the obscured independent work of authorship will produce only cacophonous sound when played. It can be appreciated that any encryption algorithm can be affixed to the independent work of authorship. It can be appreciated that the obscured independent work of authorship is entitled to copyright protection once it is created. However, additional copyright protection is provided for the obscured independent work of authorship by obtaining a copyright registration on the obscured independent work of authorship.

The media manipulator 130 can include an additional media data generator 135 configured to provide a separate message to a user of the independent work of authorship 150 once the user is authorized to receive the independent work of authorship. In one embodiment, the separate message to the user is a video. In another embodiment, the separate message is an advertisement.

The system 100 outputs an independent work of authorship 150 and/or an obscured independent work of authorship 160. The independent work of authorship 150 and the obscured independent work of authorship are entitled to their own copyright protection because they are new and different sounds that simulate or imitate the sounds contained in the copyrighted media recording. The independent work of authorship 150 is perceived by the human ear to be near perfect simulations of the copyrighted media recording 140. However the independent work of authorship 150 was not produced from a re-formatting program, which merely allows data to be compressed or re-formatted by mechanical means into another file type. The independent work of authorship 150 contains nothing that was carried over form the copyrighted media recording. The sounds of the copyrighted media recording 140 were not edited, filtered, enhanced or altered in any way.

Moreover, the independent work of authorship 150 was not created by duplicating sounds of the copyrighted media recording 140 by directly or indirectly recapturing the sounds fixed in the copyrighted media recording. The independent work of authorship 150 is not a derivative work in which the actual sounds fixed in the copyrighted media recording 140 are rearranged, remixed or otherwise altered in sequence or quality. In one embodiment, the independent work of authorship 150 is a simulation based upon artistic decision making of how the perception of the live performance of the copyrighted media recording 140 would be heard by a listener present during that performance. Accordingly, the independent work of authorship 150 and the obscured independent work of authorship 160 are entitled to copyright royalties thereon, which will be described in detail later. Additionally, not only will the independent work of authorship 150 and the obscured independent work of authorship 160 be subject to generating royalties, they are subject to registration for copyright protection.

The system 100 distributes the independent work of authorship 150 to a requesting user. In one embodiment, the system 100 distributes the obscured independent work of authorship 160 to a user that requests the independent work of authorship 150. If the user does not have requisite authority and consent, the user will observe an obscured independent work of authorship 160 when played. However, if the user has requisite authority and consent, the user will observe the independent work of authorship 150 when played.

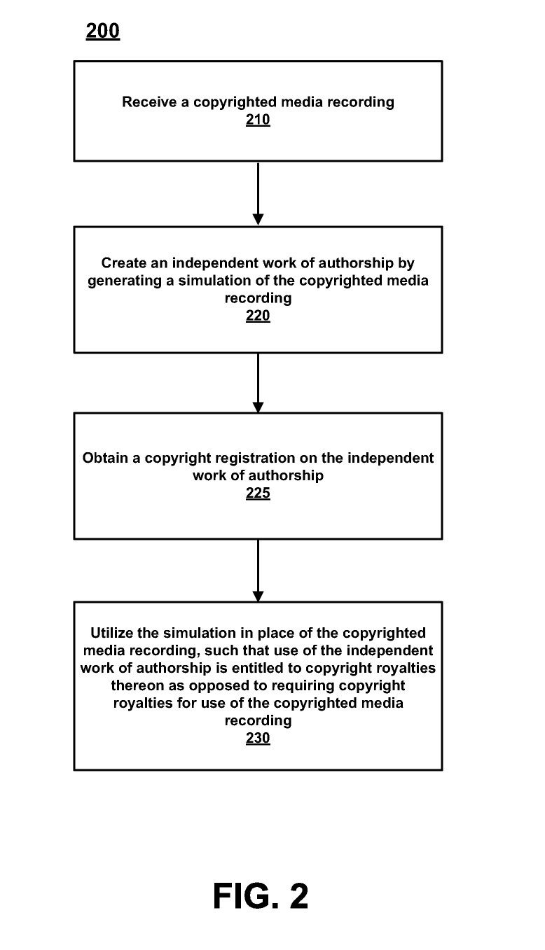

FIG. 2 is a flowchart illustrating method 200 of enhancing copyright revenue generation. Although specific operations are disclosed in method 200, such steps are examples. That is, embodiments of the present invention are well-suited to performing various other operations or variations of the operations recited in method 200. The operations in method 200 may be performed in an order different than presented, and it is possible that not all of the operations in method 200 are performed. All of, or a portion of, the operations described by method 200 may be implemented using computer-readable and computer-executable instructions which reside, for example, in computer-usable media of a computer system, such as but not limited to the computer system in FIG. 3. In one embodiment, process 200 is performed in a computer system, e.g., system 300 of FIG. 3. In another embodiment, process 200 is performed on a system, e.g. system 100 of FIG. 1. It should be appreciated that various operations have been left out of the following discussion for purposes of brevity and clarity. The goal of method 200 is for enhancing copyright revenue generation.

At block 210 of FIG. 2, a copyrighted media recording is received. At block 220, an independent work of authorship is created by generating a simulation of the copyrighted media recording, such that the independent work of authorship is entitled to a copyright. At block 230, the simulation is utilized in place of the copyrighted media recording, such that the use of the independent work of authorship may be entitled to copyright royalties thereon as opposed to requiring copyright royalties for use of the copyrighted media recording.

In one embodiment, the creating of an independent work of authorship by generating a simulation includes creating the independent work of authorship by generating a psychoacoustic simulation of the copyrighted media recording. In another embodiment, the independent work of authorship is obscured such that the independent work of authorship is not fully perceptible without authority of a copyright owner of the independent work of authorship. In a further embodiment, the independent work of authorship is obscured with additional media data which provides a separate message to a user of the independent work of authorship once the user is authorized to receive the independent work of authorship. The independent work of authorship is entitled to copyright protection and related copyright royalties thereon. Accordingly, the obscured independent work of authorship creates a second independent work of authorship which is also entitled to copyright registration and copyright royalties thereon. In another embodiment, the method 200 transmits the obscured independent work of authorship when a user requests the independent work of authorship to prevent illicit copying.

In one embodiment, a copyright registration is obtained on the independent work of authorship and copyright royalties are entitled thereon. In another embodiment, a copyright registration is obtained on the obscured independent work of authorship and copyright royalties are entitled thereon.

In one embodiment, the creating of an independent work of authorship creates a media that is different than said copyrighted media recording. In one embodiment, the copyrighted media recording is a sound recording and the independent work of authorship is an audiovisual media. Accordingly, the audiovisual media would be entitled to copyright protection and copyright royalties thereon. In another embodiment, a created audiovisual work is a derivative work. The audiovisual work is derived by but not limited to reformatting. For example, the derivative work is a sampled version of the copyrighted media recording. The copyrighted media recording is modified in some manner by a mechanical means such as but not limited to a filter. To lawfully make the aforementioned derivative work, express consent by the copyright holder of the copyrighted media recording is required.

In one embodiment, method 200 provides for a copyright owner of the independent work of authorship to receive copyright royalties from the independent work of authorship that otherwise would have been received by a copyright owner of the copyrighted media recording. In general, if a copyrighted sound recording is transmitted to a user, the party transmitting the copyrighted sound recording is required to pay copyright royalties for the transmitted sound recording. The entitled copyright royalties can be but are not limited to a performance royalty and a publishing royalty. Generally, the performance is paid to the performers of the sound recording. The publishing royalty is paid to the songwriter of the lyrics of the song. Accordingly, if a party transmits an independent work of authorship, as described above, and the party owns the copyright of the independent work of authorship, the party is not required to pay a performance royalty that would otherwise have been paid to the owner of the copyright of the copyrighted media recording. However, the copyright owner of the independent work of authorship is required to pay a publishing royalty to the songwriter of the sound recording who wrote the lyrics to the sound recording. Therefore, there is an enhancing of copyright revenue generation because the party transmitting the independent work of authorship is entitled to copyright royalties (e.g. performance royalties) thereon that would have otherwise have been paid to the owner of the of the copyright of the copyrighted media recording. Additionally, not only will the independent work of authorship and the obscured independent work of authorship be subject to generating royalties, they are subject to registration for copyright protection.

Currently, for example, Apple Inc. of Cuppertino, Calif., provides for copyrighted songs to be purchased on iTunes Store, an online digital media store, and played on iTunes, a digital media player application. Apple Inc. initially obtains sufficient rights to a song that is provided for purchase and download at the iTunes Store. Upon purchase and download of the song to an end user, Apple Inc. is required to pay copyright royalties of the transmitted copyright song, such as but not limited to performance and publishing royalties. If Apple Inc. sells one copyrighted song to an end user for $1, Apple Inc. is currently required to pay approximately a $0.70 performance royalty and a few cents publishing royalty. If, however, an online digital store, such as iTunes Store, created an independent work of authorship and retained a copyright for the independent work of authorship, Apple Inc. would not be required to pay the performance royalty of a copyrighted song (e.g., $0.70) but instead could charge a performance royalty which would enhance the copyright revenue generation of Apple Inc. Nevertheless, Apple Inc. does not create an independent work of authorship from a copyrighted media recording, as described above, and is currently required to pay at least a performance and publishing royalty for each song transmitted to an end user.

### Example Computer System Environment

With reference now to FIG. 3, portions of the technology for providing a communication composed of computer-readable and computer-executable instructions that reside, for example, in computer-usable media of a computer system. That is, FIG. 3 illustrates one example of a type of computer that can be used to implement embodiments of the present technology.

FIG. 3 illustrates an example computer system 300 used in accordance with embodiments of the present technology. It is appreciated that system 300 of FIG. 3 is an example only and that the present technology can operate on or within a number of different computer systems including general purpose networked computer systems, embedded computer systems, routers, switches, server devices, user devices, various intermediate devices/artifacts, stand alone computer systems, mobile phones, personal data assistants, and the like. As shown in FIG. 3, computer system 300 of FIG. 3 is well adapted to having peripheral computer readable media 302 such as, for example, a floppy disk, a compact disc, and the like coupled thereto.

It should be noted that embodiments of the present technology are well suited to use in various portable electronic devices. For purposes of the present application, the term “portable electronic device” is not intended to be limited solely to conventional handheld or portable computers. Instead, the term “portable electronic device” is also intended to include many mobile electronic devices. Such mobile devices include, but are not limited to, portable CD players, MP3 players, mobile phones, portable recording devices, and other personal digital devices.

System 300 of FIG. 3 includes an address/data bus 304 for communicating information, and a processor 306A coupled to bus 304 for processing information and instructions. As depicted in FIG. 3, system 300 is also well suited to a multi-processor environment in which a plurality of processors 306A, 306B, and 306C are present. Conversely, system 300 is also well suited to having a single processor such as, for example, processor 306A. Processors 306A, 306B, and 306C may be any of various types of microprocessors. System 300 also includes data storage features such as a computer usable volatile memory 308, e.g. random access memory (RAM), coupled to bus 304 for storing information and instructions for processors 306A, 306B, and 306C.

System 300 also includes computer usable non-volatile memory 310, e.g. read only memory (ROM), coupled to bus 304 for storing static information and instructions for processors 306A, 306B, and 306C. Also present in system 300 is a data storage unit 312 (e.g., a magnetic or optical disk and disk drive) coupled to bus 304 for storing information and instructions. System 300 also includes an optional alpha-numeric input device 314 including alphanumeric and function keys coupled to bus 304 for communicating information and command selections to processor 306A or processors 306A, 306B, and 306C. System 300 also includes an optional cursor control device 316 coupled to bus 304 for communicating user input information and command selections to processor 306A or processors 306A, 306B, and 306C. System 300 of the present embodiment also includes an optional display device 318 coupled to bus 304 for displaying information.

Referring still to FIG. 3, optional display device 318 of FIG. 3 may be a liquid crystal device, cathode ray tube, plasma display device or other display device suitable for creating graphic images and alpha-numeric characters recognizable to a user. Optional cursor control device 316 allows the computer user to dynamically signal the movement of a visible symbol (cursor) on a display screen of display device 318. Many implementations of cursor control device 316 are known in the art including a trackball, mouse, touch pad, joystick or special keys on alpha-numeric input device 314 capable of signaling movement of a given direction or manner of displacement. Alternatively, it will be appreciated that a cursor can be directed and/or activated via input from alpha-numeric input device 314 using special keys and key sequence commands.

System 300 is also well suited to having a cursor directed by other means such as, for example, voice commands. System 300 also includes an I/O device 320 for coupling system 300 with external entities. For example, in one embodiment, I/O device 320 is a modem for enabling wired or wireless communications between system 300 and an external network such as, but not limited to, the Internet. A more detailed discussion of the present technology is found below.

Referring still to FIG. 3, various other components are depicted for system 300. Specifically, when present, an operating system 322, applications 324, modules 326, and data 328 are shown as typically residing in one or some combination of computer usable volatile memory 308, e.g. random access memory (RAM), and data storage unit 312. However, it is appreciated that in some embodiments, operating system 322 may be stored in other locations such as on a network or on a flash drive; and that further, operating system 322 may be accessed from a remote location via, for example, a coupling to the internet. In one embodiment, the present technology, for example, is stored as an application 324 or module 326 in memory locations within RAM 308 and memory areas within data storage unit 312. The present technology may be applied to one or more elements of described system 300. For example, a method of modifying user interface 225A of device 115A may be applied to operating system 322, applications 324, modules 326, and/or data 328.

The computing system 300 is only one example of a suitable computing environment and is not intended to suggest any limitation as to the scope of use or functionality of the present technology. Neither should the computing environment 300 be interpreted as having any dependency or requirement relating to any one or combination of components illustrated in the example computing system 300.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims

1. A method of enhancing copyright revenue generation, said method comprising:
receiving a copyrighted media recording;
creating an independent work of authorship by generating a simulation of said copyrighted media recording, such that said independent work of authorship is entitled to a copyright; and
utilizing said simulation in place of said copyrighted media recording, such that use of said independent work of authorship may be entitled to copyright royalties thereon as opposed to requiring copyright royalties for use of said copyrighted media recording.

2. The method of claim 1, wherein said creating an independent work of authorship by generating a simulation further comprises:
creating said independent work of authorship by generating a psychoacoustic simulation of said copyrighted media recording.

3. The method of claim 1, wherein said method further comprises:
obscuring said independent work of authorship such that said independent work of authorship is not fully perceptible without authority of a copyright owner of said independent work of authorship.

4. The method of claim 3, wherein said independent work of authorship is obscured with additional media data which provides a separate message to a user of said independent work of authorship once said user is authorized to receive said independent work of authorship.

5. The method of claim 3, wherein said obscuring said independent work of authorship creates a second independent work of authorship which is also entitled to copyright royalties thereon.

6. The method of claim 3, wherein said method further comprises:
transmitting said obscured independent work of authorship when a user requests said independent work of authorship.

7. The method of claim 1, wherein said creating an independent work of authorship creates a media that is different than said copyrighted media recording.

8. The method of claim 1, wherein said method further comprises:
receiving copyright royalties from said independent work of authorship that otherwise would have been received by a copyright owner of said copyrighted media recording.

9. The method of claim 1, wherein said method further comprises:
obtaining a copyright registration on said independent work of authorship.

10. A system for enhancing copyright revenue generation, said system comprising:
a receiver configured to receive a copyrighted media recording; and
a simulator configured to analyze a copyrighted media recording and generate an independent work of authorship based on an analysis of said copyrighted media recording, such that said independent work of authorship is entitled to a copyright and use of said independent work of authorship may be entitled to copyright royalties thereon as opposed to requiring copyright royalties for use of said copyrighted media recording.

11. The system of claim 10, wherein said system further comprises:
a media manipulator configured to obscure said independent work of authorship and create an obscured independent work of authorship, such that said independent work of authorship is not fully perceptible without authority of a copyright owner of said independent work of authorship.

12. The system of claim 11, wherein said media manipulator further comprises:
an additional media data generator configured to provide a separate message to a user of said independent work of authorship once said user is authorized to receive said independent work of authorship.

13. The system of claim 11, wherein said obscured independent work of authorship is also entitled to copyright royalties thereon.

14. The system of claim 11, wherein said system transmits said obscured independent work of authorship to a user requesting said independent work of authorship.

15. The system of claim 10, wherein said simulator further comprising:
a psychoacoustic simulator configured to psychoacoustically analyze said copyrighted media recording and create an independent work of authorship by generating a psychoacoustic simulation of said copyrighted media recording.

16. A method of enhancing copyright revenue generation, said method comprising:
receiving a copyrighted media recording;
creating an independent work of authorship by generating a psychoacoustic simulation of said copyrighted media recording, such that said independent work of authorship is entitled to a copyright;
utilizing said psychoacoustic simulation in place of said copyrighted media recording, such that use of said independent work of authorship may be entitled to copyright royalties thereon as opposed to requiring copyright royalties for use of said copyrighted media recording; and
obscuring said independent work of authorship such that said independent work of authorship is not fully perceptible without authority of a copyright owner of said independent work of authorship, wherein said obscuring said independent
work of authorship creates a second independent work of authorship which is also entitled to a copyright and copyright royalties thereon.
